(19) United States
(12) Patent Application Publication
(10) Pub. No.: US 2018/0053086 A1
(43) Pub. Date: Feb. 22, 2018

(54) ARTIFICIAL NEURON AND CONTROLLING METHOD THEREOF

(71) Applicant: Kneron Inc., San Diego, CA (US)

(72) Inventors: Chun-Chen Liu, San Diego, CA (US); Kangli Hao, San Diego, CA (US); Liu Liu, San Diego, CA (US)

(21) Appl. No.: 15/243,907

(22) Filed: Aug. 22, 2016

(51) Int. Cl. G06N 3/063; G06N 3/04

(52) U.S. Cl. CPC G06N 3/063; G06N 3/04

(57) ABSTRACT

A neural network including a controller and plural neurons is provided. The controller is configured to generate a forward propagation instruction in a computation process. Each neuron includes an instruction register, a storage device, and an application-specific computation circuit. The instruction register is configured to receive the forward propagation instruction from the controller and temporarily storing the forward propagation instruction. The storage device is configured to store at least one input and at least one learnable parameter. The application-specific computation circuit is invariably configured to dedicate to computations related to the neuron. In response to the forward propagation instruction received by the instruction register, the application-specific computation circuit is configured to perform a computation on the at least one input and the at least one learnable parameter according to an activation function and to feed back a computation result to the storage device.

### BACKGROUND OF THE INVENTION

### 1. Field of the Invention

The present invention relates to artificial neural networks. In particular, the present invention relates to techniques for implementing artificial neurons.

### 2. Description of the Prior Art

The idea of artificial neural networks has existed for a long time. Nevertheless, limited computation ability of hardware had been an obstacle to related researches. Over the last decade, there are significant progresses in computation capabilities of processors and algorithms of machine learning. Not until recently did an artificial neural network that can generate reliable judgements become possible. Gradually, artificial neural networks are experimented in many fields such as autonomous vehicles, image recognition, natural language understanding, and data mining.

Neurons are the basic computation units in a brain. Each neuron receives input signals from its dendrites and produces output signals along its single axon (usually provided to other neurons as input signals). The typical operation of an artificial neuron can be modeled as:

$$y = f ( {\sum }_{i} {w}_{i} {x}_{i} + b ) ,$$

wherein x represents the input signal, y represents the output signal. Each dendrite multiplies a weight w to its input signal x; this parameter is used to simulate the strength of influence of one neuron on another. The symbol b represents a bias contributed by the artificial neuron itself. During the process of machine learning, the weights and bias of a neuron may be modified over and over again. Therefore, these parameters are also called learnable parameters. The symbol f represents an activation function and is generally implemented as a sigmoid function, hyperbolic tangent (tanh) function, or rectified linear function in practical computation.

Currently, most artificial neural networks are designed as having a multi-layer structure. Layers serially connected between the input layer and the output layer are called hidden layers. The input layer receives external data and does not perform computation. In a hidden layer or the output layer, input signals are the output signals generated by its previous layer, and each artificial neuron therein respectively performs computation according to the aforementioned equation. Each hidden layer and output layer can respectively be a convolutional layer or a fully-connected layer. At the present time, there are a variety of network structures. Each structure has its unique combination of convolutional layers and fully-connected layers. Taking the AlexNet structure proposed by Alex Krizhevsky et al. in 2012 as an example, the network includes 650,000 artificial neurons that form five convolutional layers and three fully-connected layers connected in serial. When a complicated judgment is required, an artificial neural network may include up to twenty-nine computational layers.

To deal with such a huge computation amount, an artificial neural network at the present time is usually implemented by a supercomputer or a multi-core central processing unit. Because these large-scale processors are originally designed for performing diverse computations, inside there are lots of generic computation units (e.g. circuits for performing adding function, subtracting function, multiplying function, dividing function, trigonometric function, exponential function, logarithmic function, . . . , etc.) and lots of logical units (e.g. AND gates, OR gates, XOR gates, . . . , etc.) However, for computations in an artificial neural network, many circuits in these large-scale processors are unnecessary or unsuitable. Implementing an artificial neural network in this way usually leads to over-wasting in hardware resources. In other words, an artificial neural network may include a lot of dispensable circuits and the overall cost is raised.

### SUMMARY OF THE INVENTION

To solve the aforementioned problem, a new artificial neuron and controlling method thereof are provided.

One embodiment according to the invention is a neural network including a controller and a plurality of neurons. The controller is configured to generate a forward propagation instruction in a computation process. Each neuron includes an instruction register, a storage device, and an application-specific computation circuit. The instruction register is configured to receive and temporarily store the forward propagation instruction provided by the controller. The storage device is configured to store at least one input data and at least one learnable parameter for this neuron. The application-specific computation circuit is configured to dedicate on computations related to the neuron. In response to the forward propagation instruction received by the instruction register, the application-specific computation circuit performs a computation on the at least one input and the at least one learnable parameter according to an activation function and to feed back a computation result to the storage device.

Another embodiment according to the invention is an artificial neuron including a storage device and a computation circuit. The storage device is configured to store at least one input, at least one learnable parameter, and a look-up table including plural sets of parameters that describe an activation function. The computation circuit is configured to first generate an index based on the at least one input and the at least one learnable parameter, and then find out, based on the look-up table, an output value corresponding to the index in the activation function as a computation result of this neuron.

Another embodiment according to the invention is a controlling method for an artificial neuron. First, an index is generated based on at least one input and at least one learnable parameter of this artificial neuron. Then, based on a look-up table including plural sets of parameters that describe an activation function, an output value corresponding to the index in the activation function is found out and taken as a computation result of this artificial neuron.

The advantage and spirit of the invention may be understood by the following recitations together with the appended drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a two-layer artificial neural network as an example of the neural network according to the invention.

FIG. 2 illustrates the function block diagram of a neuron in one embodiment according to the invention.

FIG. 3 shows the flowchart of a neuron controlling method in one embodiment according to the invention.

The figures described herein include schematic block diagrams illustrating various interoperating functional modules. It should be noted that such diagrams are not intended to serve as electrical schematics and interconnections illustrated are intended to depict signal flow, various interoperations between functional components and/or processes and are not necessarily direct electrical connections between such components. Moreover, the functionality illustrated and described via separate components need not be distributed as shown, and the discrete blocks in the diagrams are not necessarily intended to depict discrete electrical components.

### DETAILED DESCRIPTION

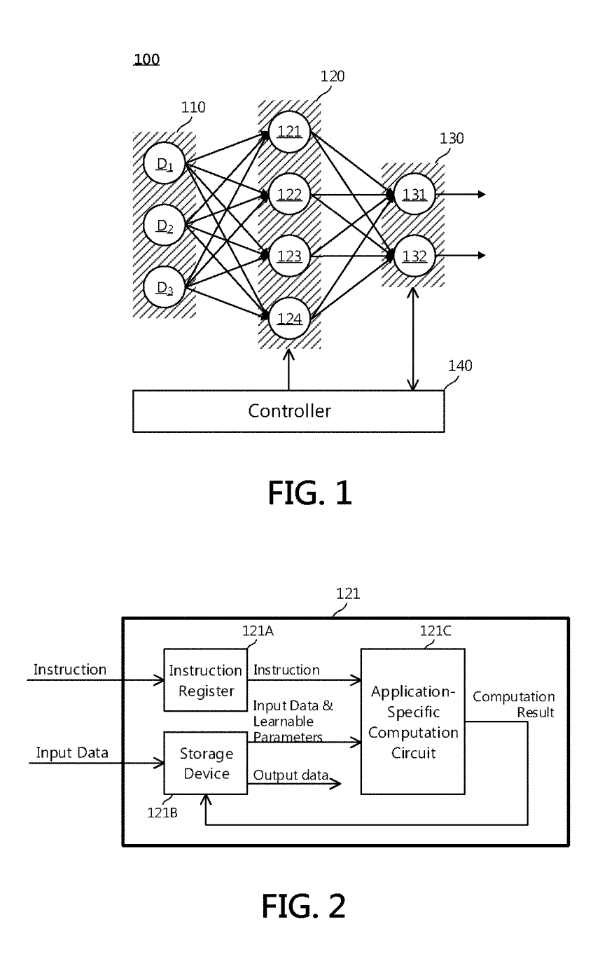

One embodiment according to the invention is a neural network including a controller and a plurality of neurons. FIG. 1 shows a two-layer artificial neural network as an example of this neural network. It should be noted that although actual artificial neural networks include much more artificial neurons and have much more complicated interconnections than this example, those ordinarily skilled in the art can understand, through the following introduction, the scope of the invention is not limited to a specific network complexity.

Please refer to FIG. 1. The input layer 110 is used for receiving external data D1˜D3. The hidden layer 120 and output layer 130 are both fully-connected layers and respectively include four neurons (121˜124) and two neurons (131˜132). The controller 140 coupled to the two computational layers is responsible for generating instructions for controlling the neurons. Taking a neural network adopting supervised learning as an example, in a training process, the controller 140 can first generate and send out a forward propagation instruction, so as to control the neurons to perform computations according to learnable parameters to be trained. Then, based on the difference between ideal results and training results generated, the controller 140 judges whether the learnable parameters at the present time should be adjusted. If the controller 140 determines the learnable parameters should be further adjusted, the controller 140 can generate and send out a backward propagation instruction.

If plural sets of training data are sequentially provided to the neural network 100, the controller 140 can alternatively and repeatedly sends out the above two instructions to the neurons. The learnable parameters of the neurons will be accordingly modified over and over again until the difference between ideal results and training results is converged to be lower than a predetermined threshold. The training process is then completed at that time. Thereafter, in normal computation processes, the controller 140 can generate and send out a forward propagation instruction, so as to request the neurons to perform computations according to learnable parameters determined by the training process.

In the neural network 100, each neuron respectively includes an instruction register, a storage device, and an application-specific computation circuit. The neuron 121 in the hidden layer 120 is taken as an example, and the connections between its components are illustrated in FIG. 2. The instruction register 121A is configured to receive and temporarily store instructions provided by the controller 140. The storage device 121B is configured to store input data (D1˜D3) and learnable parameters (including one bias b and three weights w respectively corresponding to external data D1˜D3) of the neuron 121.

The application-specific computation circuit 121C is specifically designed for computations responsible by the neuron 121. In other words, the application-specific computation circuit 121C is configured to dedicate on computations related to the neuron 121. First consider computations related to a forward propagation instruction. In response to a forward propagation instruction received by the instruction register 121A, the application-specific computation circuit 121C performs computations on input data and learnable parameters stored in the storage device 121B. Then, the computation result is fed back to the storage device 121B. If the activation function of the neuron 121 is a hyperbolic tangent function, aiming at computations related to a forward propagation instruction, the application-specific computation circuit 121C can be fixedly configured as only including circuits needed for performing a hyperbolic tangent function. For example, the application-specific computation circuit 121C can include only plural multipliers, one adder, one divider, and a circuit for performing exponential function. The multipliers are configured to multiply each input data with a corresponding weight w. The adder sums up the weighted values with a bias b; this summation result is the input value of the activation function. Then, based on the input value, the divider and exponential function circuit can generate a corresponding output value of the hyperbolic tangent function.

Now consider computations related to a backward propagation instruction. In response to a backward propagation instruction received by the instruction register 121A, the application-specific computation circuit 121C performs a backward propagation computation and feeds back its computation results (i.e. modified learnable parameters) to the storage device 121B. Aiming at computations related to a backward propagation instruction, the application-specific computation circuit 121C can be fixedly configured as only including a subtracter, an adder, and a multiplier.

Practically, since a forward propagation instruction and a backward propagation instruction do not come about at the same time, circuits for performing these two instructions can be shared, so as to further reduce components in the application-specific computation circuit 121C.

It is noted that computation details related to the above two instructions may have lots of variations. For example, the activation function of the neuron 121 can be a sigmoid function, a rectified linear function, or a multi-segment linear function instead. With respect to different activation functions, circuit components included in the application-specific computation circuit 121C might be different. For another example, the same activation function can usually be represented by a variety of mathematic equations. Accordingly, required circuit components would be different, too. The variations of each activation function, the computation details, and corresponding circuit components are comprehended by those skilled in the art and not enumerated.

In summary, the application-specific computation circuit 121C can include only circuit components for performing computations related to forward and backward propagation instructions. Compared with a large-scale processor, the neuron structure and number of circuits shown in FIG. 2 are obviously much simpler. The hardware cost to implement a neural network can accordingly be reduced. Moreover, because there are less type of instructions in the neural network 100, the routing between the instruction register 121A and the application-specific computation circuit 121C can be simple and few.

The scope of the invention is not limited to a specific storage mechanism. Practically, the storage device 121B can include one or more volatile or non-volatile memory device, such as a dynamic random access memory (DRAM), a magnetic memory, an optical memory, a flash memory, etc. Physically, the storage device 121B can be a single device disposed adjacent to the application-specific computation circuit 121C. Alternatively, the storage devices of plural neurons can be integrated into a larger memory.

Moreover, the controller 140 can be implemented by a variety of fixed and/or programmable logic, such as field-programmable logic, application-specific integrated circuits, microcontrollers, microprocessors and digital signal processors. The controller 140 may also be designed as executing a process stored in a memory as executable instructions.

In one embodiment, the storage device 121B further stores a look-up table including plural sets of parameters that describe an activation function. More specifically, the plural sets of parameters describe the input/output relationship of the activation function. Under this condition, the application-specific computation circuit 121C can be configured as including only plural multipliers and one adder for generating an index based on input data and learnable parameters of the neuron 121. The index is an input for the activation function. Subsequently, based on the look-up table, the application-specific computation circuit 121C finds out an output value corresponding to the index in the activation function. The output value is the computation result of the neuron 121. The advantage of utilizing a look-up table herein is that non-linear computations related to the activation function can be omitted and the circuit components in the application-specific computation circuit 121C can be further simplified. For instance, the divider and exponential function circuit are not required.

In another embodiment, the application-specific computation circuit 121C is configured as dedicating to a limited number of computations respectively corresponding to different activation functions. For example, the application-specific computation circuit 121C can include two sets of circuit. One set is for performing computations corresponding to a hyperbolic tangent function, and the other set is for performing computations corresponding to a multi-segment linear function. When the neural network 100 is dealing with complicated judgements, the user can request, through the controller 140, the application-specific computation circuit 121C to take the hyperbolic tangent function as its activation function. On the contrary, when the neural network 100 is dealing with simple judgements, the application-specific computation circuit 121C can be set as taking the multi-segment linear function as its activation function. It is noted that circuit components related to these two functions may be shared. The advantage of this practice is that considerable computation flexibility can be provided without adding too many hardware in the application-specific computation circuit 121C.

In another embodiment, the neural network 100 is reconfigurable. In other words, the routing between neurons can be modified so as to change the structure of the neural network 100. Under this condition, the controller 140 can be configured to perform a reconfiguration process in which some neurons in the neural network 100 can be optionally abandoned. For example, if after a training process, the controller 140 finds out the neurons 123 and 124 have little influence on the final output generated by the output layer 130, the controller 140 can generate an abandoning instruction and provide the abandoning instruction to the neurons 123 and 124. Thereby, the controller 140 can request the application-specific computation circuits in the neurons 123 and 124 not to perform any computation.

Another embodiment according to the invention is an artificial neuron including a storage device and a computation circuit. Practically, the computation circuit herein can be the application-specific computation circuit shown in FIG. 2 or another type of processor. The storage device is configured to store at least one input, at least one learnable parameter, and a look-up table including plural sets of parameters that describe an activation function. The computation circuit is configured to first generate an index based on the at least one input and the at least one learnable parameter, and then find out, based on the look-up table, an output value corresponding to the index in the activation function as a computation result of this neuron. In other words, the idea of utilizing a look-up table in performing an activation function can be applied to other hardware structure and achieve the effect of reducing computation complexity.

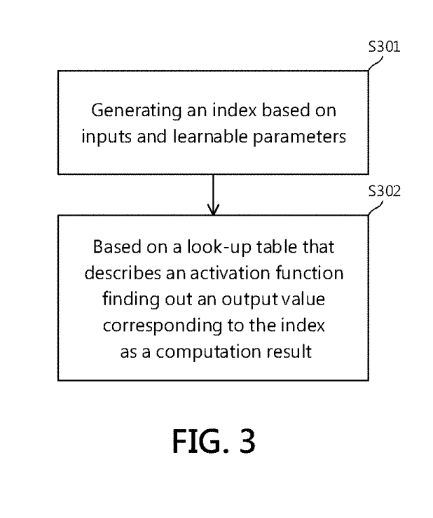

Another embodiment according to the invention is a controlling method for an artificial neuron. The flowchart of this controlling method is shown in FIG. 3. First, in step S301, an index is generated based on at least one input and at least one learnable parameter of this artificial neuron. Then, in step S302, based on a look-up table including plural sets of parameters that describe an activation function, an output value corresponding to the index in the activation function is found out and taken as a computation result of this artificial neuron. Those ordinarily skilled in the art can comprehend that the variety of variations described above can also be applied to the controlling method in FIG. 3 and the details are not described again.

With the example and explanations above, the features and spirits of the invention will be hopefully well described. Those ordinarily skilled in the art will readily observe that numerous modifications and alterations of the device may be made while retaining the teaching of the invention. Accordingly, the above disclosure should be construed as limited only by the metes and bounds of the appended claims. Additionally, mathematical expressions are contained herein and those principles conveyed thereby are to be taken as being thoroughly described therewith. It is to be understood that where mathematics are used, such is for succinct description of the underlying principles being explained and, unless otherwise expressed, no other purpose is implied or should be inferred. It will be clear from this disclosure overall how the mathematics herein pertain to the present invention and, where embodiment of the principles underlying the mathematical expressions is intended, the ordinarily skilled artisan will recognize numerous techniques to carry out physical manifestations of the principles being mathematically expressed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A neural network, comprising:
a controller configured to generate a forward propagation instruction in a computation process; and
a plurality of neurons, each comprising:
an instruction register configured to receive and temporarily store the forward propagation instruction provided by the controller;
a storage device configured to store at least one input data and at least one learnable parameter for this neuron; and
an application-specific computation circuit configured to dedicate on computations related to the neuron; in response to the forward propagation instruction received by the instruction register, the application-specific computation circuit performing a computation on the at least one input and the at least one learnable parameter according to an activation function and to feed back a computation result to the storage device.

2. The neural network of claim 1, wherein in a training process, the controller generates a backward propagation instruction and provides the backward propagation instruction respectively to the instruction registers in the plurality of neurons; in response to the backward propagation instruction, the application-specific computation circuit in each neuron performs a backward propagation computation, so as to modify the at least one learnable parameter for this neuron.

3. The neural network of claim 1, wherein in a reconfiguration process, the controller generates an abandoning instruction and provides the abandoning instruction to one or more neuron among the plurality of neurons, so as to request the application-specific computation circuit in the one or more neuron not to perform any computation.

4. The neural network of claim 1, wherein the activation function is a sigmoid function, a hyperbolic tangent function, a rectified linear function, or a multi-segment linear function.

5. The neural network of claim 1, wherein in a neuron among the plurality of neurons, the storage device further stores a look-up table including plural sets of parameters that describe the activation function; the application-specific computation circuit first generates an index based on the at least one input and the at least one learnable parameter for this neuron, and then finds out, based on the look-up table, an output value corresponding to the index in the activation function as the computation result for this neuron.

6. The neural network of claim 1, wherein the application-specific computation circuit is configured as dedicating to a limited number of computations respectively corresponding to different activation functions.

7. An artificial neuron, comprising:
a storage device configured to store at least one input, at least one learnable parameter, and a look-up table including plural sets of parameters that describe an activation function; and
a computation circuit configured to first generate an index based on the at least one input and the at least one learnable parameter, and then find out, based on the look-up table, an output value corresponding to the index in the activation function as a computation result of this neuron.

8. The artificial neuron of claim 7, wherein the activation function is a sigmoid function, a hyperbolic tangent function, a rectified linear function, or a multi-segment linear function.

9. A controlling method for an artificial neuron, comprising:
generating an index based on at least one input and at least one learnable parameter of this artificial neuron; and
finding out, based on a look-up table including plural sets of parameters that describe an activation function, an output value corresponding to the index in the activation function as a computation result of this artificial neuron.

10. The controlling method of claim 9, wherein the activation function is a sigmoid function, a hyperbolic tangent function, a rectified linear function, or a multi-segment linear function.
